(19) United States
(12) Patent Application Publication
(10) Pub. No.: US 2008/0119630 A1
(43) Pub. Date: May 22, 2008

(54) Flame-Resistant, Low-Temperature Curing Cyanate-Based Resins with Improved Properties

(75) Inventors: Monika Bauer, Berlin (DE); Rajko Wurzel, Birkenhain (DE); Christoph Uhlig, Berlin (DE); Jorg Bauer, Berlin (DE)

Correspondence Address: GUDRUN E. HUCKETT DRAUDT, SCHUBERTSTR. 15A, WUPPERTAL, 42289, omitted

(73) Assignee: Fraunhofer-Gesellschaft zur Forderung der angewandten Forschung e.V., Munchen (DE)

(21) Appl. No.: 11/747,269

(22) Filed: May 11, 2007

(30) Foreign Application Priority Data
May 11, 2006 (DE) 10 2006 022 058.7
Sep. 1, 2006 (DE) 10 2006 041 037.8
Dec. 22, 2006 (DE) 10 2006 062 248.0

(51) Int. Cl. C08G 18/00

(52) U.S. Cl. 528/65

(57) ABSTRACT

A prepolymer is prepared from a starting material a) of one or more bifunctional or polyfunctional organic cyanates; and a starting material b) of one or more bifunctional or polyfunctional aromatic alcohols and/or one or more bifunctional or polyfunctional aliphatic alcohols substituted in the aliphatic group with at least one fluorine atom, wherein the starting materials a) and b) are present in a weight ratio ensuring a molar ratio of the OCN groups to the OH groups between 95:5 and 70:30 in the starting materials a) and b). The prepolymer has a degree of crosslinking that is below the gel point of the prepolymer.

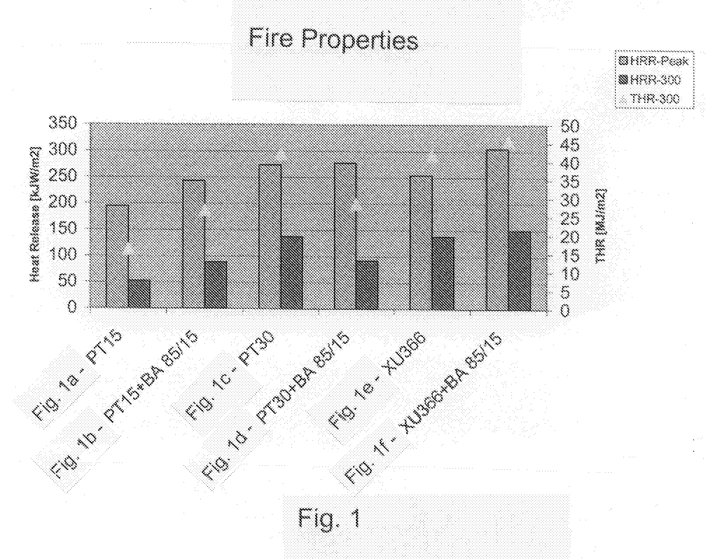

### BACKGROUND OF THE INVENTION

The invention concerns resins (prepolymers) made from dicyanates or polycyanates and multifunctional alcohols; additionally, the resins may contain suitable rheologic modifiers and/or other fillers.

For manufacturing shaped parts, for example, from casting resins, coated web materials, adhesives, bonding agents and other materials, lightweight plastic materials are often needed that, after curing, have excellent surface properties, that are fire retardant or act as a fire retardant, and, at the same time, can be mechanically very stable. The requirements posed in regard to fire behavior often include minimal combustibility, minimal heat release rate, low smoke density as well as minimal toxicity of the fumes generated in a fire.

For this purpose, liquid or viscous resins can be used that can be further crosslinked by means of heat and/or pressure. Because of the aforementioned high requirements in regard to fire behavior, resins suitable for such a purpose are primarily phenolic resins. Phenolic resins however cannot provide the required mechanical properties; for applications in which, for example, impact loads occur, their high brittleness is often a problem. Moreover, phenolic resins are produced by a polycondensation reaction in which light (low mass) and thus low volatile components are released. When curing such resins, the low volatile compounds convert to the gaseous state. This can cause the surface quality of shaped parts produced from such materials to be unsatisfactory, for example, because of bubble formation.

Moreover, when producing resins for different applications special requirements are to be fulfilled. One example is the adhesive behavior (so-called tack or reactivation of tack) that must be ensured optionally by modifications (formulation) of the resin. Such a tack behavior is required, for example, for adhesives, casting resins, binders for laminates, or binding agents. Bubble formation in certain applications can lead to flaws in the adhesive surfaces.

In order to formulate resins from which shaped parts can be generated with excellent surfaces, the use of addition resins appears to be more promising than the use of condensation resins because during curing no gasses are released. Addition resins with excellent mechanical properties are epoxide resins and cyanate resins. However, the epoxide resins that are commercially available today are not sufficiently flame-resistant for certain purposes because they have an increased (impermissible) fire load, especially smoke density. In the field of electronics halogen-substituted epoxide resins are known that exhibit high flame resistance; but in the case of fire the use of halogens leads to the generation of highly toxic and highly corrosive gases so that the use of halogen-substituted epoxide resins is not possible.

Cyanate resins instead exhibit already an intrinsic flame resistance because of their crosslinked structure (as a result of the high nitrogen contents). They combine a low heat release rate with a minimal smoke density and a low proportion of toxic gases in a fire situation.

The effect of multifunction phenols on crosslinking of cyanate resins has been studied already based on a model system of bisphenol A-dicyanate and bisphenol A or brominated bisphenol A under consideration of theoretical and in particular kinetic aspects; see, for example, M. Bauer et al.: Makromol. Chem., Macromol. Symp 45, 97-103 (1991); M. Bauer, Pure and Modified Polycyanurates—Polymers with Great Future as Adhesives, Casting Resins and Binders for Laminates, Acta Polymer. 43, 299-302 (1992). Resins of bisphenol A-dicyanate and bisphenol A or its brominated derivatives are therefore not the subject matter of this invention. The product spectrum of conversion of the dicyanate derivatives of bisphenol A (DCBA) with 4,4′-thiodiphenol has been analyzed by mass spectroscopy in the doctoral thesis authored by Daniela S. Glaser; Analyse der Molekülstrukturen und des Netzwerkaufbaus von mono-und difunktionellen Cyanaten bei Coreaktion mit Thiolen und Alkoholen (translation: Analysis of the Molecular Structures and of the Crosslinked Configuration of monofunctional and bifunctional Cyanates by Co-reaction with Thiols and Alcohols); Technische Hochschule Cottbus, 23 Apr. 2003.

In the literature there are a few proposals for the use of cyanate resins. For example, the Japanese abstract published under publication No. 2002-194212 A discloses a curable resin composition for laminates or prepregs therefor that comprises a cyanate ester, a monofunctional phenol component, a polyphenylene ether resin, a flame retardant that cannot react with the cyanate ester, as well as a metal-containing reaction catalyst. The heat-resistant shapeable resin is used to produce a prepreg and a laminate. The Japanese abstract with publication No. 2002-146185 proposes a similar resin; however, instead of the polyphenylene ether resin a polyethylene resin is used. According to Japanese abstract with publication No. 02-302446 a prepreg and a printed circuit board produced therefrom are disclosed wherein the components for the impregnation resin is a polyaromatic cyanate, a multi-valent phenol, a polyaromatic cyanate phenol, a catalyst, and, as needed, a flame retardant. The resin composition disclosed in EP 0 889 096 A2 is also provided for use in connection with printed circuit boards; the resin composition is produced from a modified cyanate ester, a monofunctional phenol component, a polyphenylene ether resin, as well as a flame retardant.

EP 0 295 375 A2 proposes to provide prepregs with a removable (peel-off) film that is coated with silicone in order to ensure a long-lasting tack. The resin of the prepregs is comprised of a cyanate-functionalized base material that contains additional components such as epoxy resins or maleimide resins.

Japanese abstract 03-243634 A discloses a resin that is comprised of 2-30 percent by weight of the reaction product of neopentyl glycol and terephthalic acid chloride, i.e., an oligo ester having an average molecular weight of 200-2,000 and provided with hydroxy groups at both ends, as well as 98-70 percent by weight of a resin of a cyanate ester component and a bis-maleimide component. Organic and inorganic fibers are impregnated with this resin.

### SUMMARY OF THE INVENTION

It is an object of the present invention to provide resins (prepolymers) that have simultaneously the following properties:
processability/curability (with or without pressure) in the range between approximately 100 degrees Celsius and 200 degrees Celsius for a period of a few minutes;
excellent shelf life (stability when stored; storage stability);
minimal brittleness as well as a high fire resistance of the materials produced from the resins with minimal heat release rate, low smoke density as well as minimal toxicity of the fumes generated in a fire.

In specific embodiments of the invention, the resins furthermore should have a permanent tack or a tack that can be regenerated or reactivated by means of a solvent in order to ensure their use as an adhesive, bonding agent, or the like, and/or the resins should be processable to products with particularly smooth surfaces.

Finding a solution to the aforementioned object is difficult. This is so because cyanate resins that are especially flame-resistant and based on phenolic novolac, for example, PT resins of the Lonza company, have very high glass transition temperatures after complete curing. In order to achieve a complete reaction of the cyanate groups it is therefore required to apply high curing temperatures. It is also possible to cure at lower temperatures because the reaction can be accelerated, for example, by use of conventional catalysts such as metal-acetylacetonate complex; however, when using such catalyst the maximum glass transition temperature is not lowered and only the first phase of the curing reaction is accelerated. At curing temperatures way below the curing temperature required for maximum conversion of the OCN-groups, the reaction will stop at a certain OCN conversion (OCN conversion depends on the curing temperature or its spacing from the maximum glass transition temperature, i.e., the glass transition temperature at maximum OCN conversion). Below a certain conversion, the crosslinked cyanate structure becomes extremely brittle.

Accordingly, other catalysts could be looked at that, at the same time, act as crosslinking modifiers that widen the crosslinked structure and simultaneously catalyze the crosslinking reaction of the cyanate resins (trimerization). By expanding the crosslinked structure the glass transition temperature would be lowered so that curing temperatures could be selected that are lower than those required for pure cyanate ester resins; in this way, it is possible to prevent that the above described brittleness generated that is caused by too low a conversion of the OCN groups.

This search for other catalysts is however problematic. For example, the addition of monofunctional phenols described in the literature does not appear to be promising. Monofunctional phenols as they are used in the prior art are incorporated into the polymer. The basic reaction mechanism is very complex. The inventors of the present invention have found that the number of the OH groups, despite the incorporation of the phenols, remains constant. The reason is the following: for each OH group that is incorporated, another OH group is released at another location. The effect of the monofunctional phenol is therefore that a trifunctional crosslinking location becomes a bifunctional bond because the OH group creates a crosslinking chain end. In this way, the monophenols reduce the crosslinking density excessively. They are therefore not suitable for the purposes of the present invention because they lower the glass transition temperature significantly beyond any desirable degree and because the resin exhibits an undesirably high sol contents. A further disadvantage resides in that components having a relatively high volatility remain in the resin; this causes degassing later on which is to be prevented because, as already mentioned above, unsatisfactory surface qualities (bubble formation on products produced therefrom) can result, for example. Moreover, the starting components are volatile; this causes processing problems (and possibly also hazardous materials problems).

Because of the presence of hydroxy groups it must also be taken into consideration that the reaction, at least within longer time periods as they occur during extended storage, will not stop, as required, before reaching the gel point, but instead will continue until a degree of crosslinking is reached that is way beyond the gel point and thus beyond the processability (homogenous melting) of the resins.

Excellent storage stability (shelf life) is however a mandatory requirement because resins proposed and encompassed by the present invention after their preparation, either as an unshaped mass or already transferred into the final external shape, often must be stored for an extended period of time before they are converted into the final curing state by means of heat and/or pressure.

In order to ensure excellent processability of the resins, the resins may contain additional rheologic modifiers. Such modifiers or other fillers can also be desirable for improving adhesion (tack), hardness, toughness, impact resistance, hydrophilic/hydrophobic behavior or the like. These modifiers of the cyanate resins should not simultaneously negatively affect the excellent fire properties (low heat release rate, low smoke gas density, low contents of toxic gases in the case of fire). Epoxides as co-monomers are, for example, not suitable because the modification of cyanate resins, such as PT resins, with epoxides increases significantly the heat release rate as well as the smoke gas density.

In particular the flow properties or rheologic properties of the resins can be optionally adjusted in this way such that the hot curing action (for example, in a press) leads to excellent surfaces of the products.

Surprisingly, a resin or prepolymer can be provided in accordance with the present invention that fulfills all of the above requirements. This resin or prepolymer is produced by using at least one multifunctional cyanate and at least one multivalent alcohol, as defined in the independent claim, in weight ratios ensuring a molar ratio of the OCN groups to the OH groups between 95:5 and 70:30 in the starting materials for preparing the prepolymer or the resin, wherein a resin, prepared from the dicyanate derivative of bisphenol A, in which the hydroxy groups are replaced by cyanate groups, and from either bisphenol A or a brominated derivative of bisphenol A or 4,4′-thiodiphenol (TDP), is excluded from the protection sought herewith, at least inasmuch as the resin contains no additional components. Excluded are also resins whose hydroxy starting materials and cyanate starting materials are exclusively bifunctional and aliphatic in nature.

In the context of the present invention, “prepolymer”, “resin”, and “prepolymerized resin” are to be understood, respectively, to mean an addition polymer that is prepared from or by using the aforementioned starting materials.

It was found that by selecting the molar ratio of OCN groups to OH groups in the starting components in accordance with the present invention, a prepolymerization step/pre-crosslinking step under mild conditions (in general heating to between 60 degree Celsius and 140 degrees Celsius) produces a resin whose degree of crosslinking is below its gel point. When employing the aforementioned mild conditions, it is not required to stop the reaction. The reaction surprisingly stops by itself. Moreover, it was found that the pre-crosslinked resin surprisingly can be stored over extended periods of time without the degree of crosslinking increasing. The resin can therefore be stored for relatively long periods of time (in general, several weeks, for example, at room temperature or lowered temperature) before it must be converted into its final form and cured. Moreover, curing can be carried out at relatively mild conditions, in particular mild temperatures that are only some ten K up to approximately 100 K above the temperatures required for pre-crosslinking.

The cyanate resins should be preferably free of epoxide resin components.

The present invention therefore provides cyanate resins that are modified with multifunctional, primarily aromatic, alcohols which resins can be used as casting resins, adhesives, bonding agents or the like and can be cured at very moderate temperatures (between approximately 100 degrees Celsius and 200 degrees Celsius) optionally under pressure within the minute range (approximately 1 minute to 20 minutes).

Optionally present modifications of the cyanate resin (i.e., the formulations) do not affect the high flame-resistance of the resins or affect the flame resistance only minimally, i.e., the low heat release rate and low smoke density are maintained. The proportion of toxic gases is also not increased.

It should be mentioned as a surprising effect that latency is achieved even though, by employing the aromatic alcohols as defined above, components are used whose catalytic effect would lead one to expect a continuing reaction of the resins. This latency enables the manufacture, the transport, and the storage of the resins within the time frames that are conventional today in this connection.

In beneficial embodiments, at least one filler is added to the resin; with the aid of the filler(s) excellent surfaces can be obtained and/or an excellent bonding to a substrate and/or an even more improved fire protection and/or improved mechanical properties can be achieved. This filler should be present, depending on the application, preferably in quantities of up to approximately 30 percent by weight, relative to the filled resin. More preferred is the presence of the filler in quantities of approximately 1 percent by weight to 25 percent by weight, especially up to 20 percent by weight, and even more preferred are quantities of approximately 5 percent by weight to 20 percent by weight, especially up to 15 percent by weight.

Moreover, as needed, high tack can be adjusted or such tack can be reactivated by spraying on a suitable solvent, for example, isopropanol, even after extended periods of storage; this is desired frequently in connection with applications that require excellent bonding of the resin or depend on its tack properties as an adhesive or bonding agent.

By modifying the cyanates with multi-valent phenols, as defined above, curing at moderate temperatures (for example, 130 degrees Celsius or 160 degrees Celsius up to approximately 200 degrees Celsius) is possible without the intrinsic flame resistance of the pure cyanates being negatively affected (this is not the case for the known modification of the cyanates with epoxides: in this case, the flame resistance is significantly reduced).

Optionally, the reactivity can also be changed (increased more) by adding known catalysts., e.g. a metal acetylacetonate; this is known in the prior art.

A surprising effect is primarily that a combination of the above required properties—which properties are essentially diametrically opposed in most cases—is made possible with a single formulation.

The choice of the multi-functional cyanates to be used as a starting material for the resin is not critical. Principally, any at least bifunctional cyanate molecule can be used, including primarily aromatic cyanates and among those especially the bifunctional and polyfunctional cyanates of the following structures I to III:

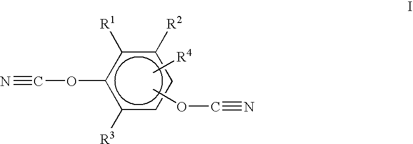

wherein R¹ to R⁴ are, independent from one another, hydrogen, C₁-C₁₀ alkyl, C₃-C₈ cycloalkyl, C₁-C₁₀ alkoxy, halogen (F, Cl, Br, or I), phenyl or phenoxy, wherein the alkyl groups or aryl groups can be fluorinated or partially fluorinated (examples are phenylene-1,3-dicyanate, phenylene-1,4-dicyanate, 2,4,5-trifluoro-phenylene-1,3-dicyanate);

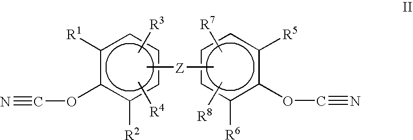

wherein R⁵ to R⁸ are the same as R¹ to R⁴ above and Z is a chemical bond, SO₂, CF₂, CH₂, CHF, CH(CH₃), isopropylene, hexafluoro isopropylene, C₁-C₁₀ alkylene, O, NR⁹, N═N, CH═CH, COO, CH═N, CH═N—N═CH, alkylene oxyalkylene with C₁-C₈ alkylene, S, Si(CH₃)₂, or

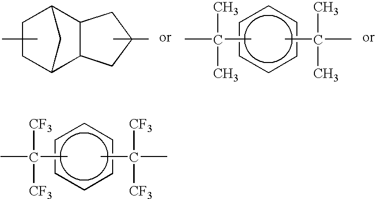

(examples are 2,2-bis(4-cyanato-phenyl) propane, 2,2-bis(4-cyanato-phenyl) hexafluoro propane, biphenylene-4,4′-dicyanate);

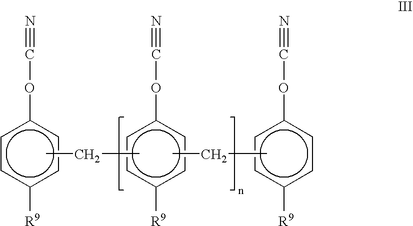

wherein R⁹ is hydrogen or C₁-C₁₀ alkyl and n is an integer of 0 to 20, as well as bifunctional or multi-functional aliphatic cyanates with at least one fluorine atom in the aliphatic residue and preferably of the structure IV:

N≡C—O—R¹⁰—O—C≡N IV

wherein R¹⁰ is a bivalent organic non-aromatic hydrocarbon with at least one fluorine atom and in particular with 3 to 12 carbon atoms, wherein its hydrogen atoms can be completely or partially substituted by further fluorine atoms.

The above cyanates can be used as monomers or as prepolymers alone or in mixtures with one another or in mixtures with additional bifunctional or polyfunctional cyanates.

As examples of especially suitable cyanates, the dicyanate of bisphenol A (4,4′-dimethylmethylene diphenyl dicyanate), 4,4′-ethylidene diphenyl dicyanate or compounds of the structural formula III should be mentioned, wherein n=1, 2, or 3, wherein R⁹ is hydrogen, and wherein the methylene group is in the ortho position relative to the cyanate group, respectively.

The multifunctional (multi-valent) aromatic or aliphatic alcohols to be used are preferably compounds of the structures I to IV listed above for the cyanates, in which structures the cyanate groups are replaced by hydroxy groups. Of course, mixtures of alcohols as defined above can be used also.

Preferably, the multi-valent aromatic alcohols are multi-valent phenols. Instead, it is also possible to employ condensed aromatic compounds, for example, naphthol derivatives. In an especially preferred embodiment, the multi-valent phenols or other aromatic compounds are divalent (bifunctional) alcohols. The hydroxy group is directly bonded to the aromatic ring, respectively.

Bisphenol A, 4,4′-ethylidene diphenol or bis(hydroxyphenyl) sulfide (also referred to as thiodiphenol or TDP) should be mentioned as examples of especially suitable bisphenols.

The material of the filler or fillers to be preferably added is selected in accordance with the criteria of the desired product properties in an appropriate way. For example, fillers such as microfillers of the type used as reinforcement materials in thermosetting resins can be used, i.e., fillers with a particle size distribution having a size concentration in the micrometer range (so-called microfillers). However, nanofillers with smaller particle sizes (particle size distribution with a size concentration below the micrometer range) are also possible, for example, aerosils, commercially available from the company Degussa, having an average particle size of smaller than 100 nm. In particular, materials such as nanofillers (for example, aerosils of the company Degussa) can contribute to an especially smooth surface of the products produced from the resins.

Independent of whether microfillers and/or nanofillers are employed, the fillers are preferably selected from inorganic fillers that are optionally organically modified and/or coated. Suitable materials are, for example, silicon dioxide, ceramic materials, organically modified silicones or siloxanes or mixtures thereof, in particular those having very high surface areas and/or small particle sizes, for example, Aerosil® of the Degussa company, bentonite that is optionally organophilically modified such as Nanofil 2 of the Südchemie company or inorganic particles that are coated with an organic coating (for example, an acrylate coating) or particles comprised of an organic-inorganic matrix, for example, of a hetero organopolysiloxane (so-called core-shell particles). The latter can be configured e.g. such that they have a soft (elastomeric) core and a hard (polymer) shell. The above materials are especially suitable in order to produce especially smooth surfaces on products to be made from the resins. Such particles can also be used to modify the fracture toughness, for example. This is especially the case when using the aforementioned core-shell particles.

The fillers can be used alone or in mixtures. It was found that mixtures of different fillers of different materials are especially well suited. Their proportion within the resin can be preferably approximately up to 20 percent by weight.

Optionally, further additives can be added to the starting material for the resins or such additives can be subsequently admixed later to the pre-polymerized resin. Examples of such additives are surface-modifying agents, for example, agents that reduce the surface tension, e.g. fluorocarbon modified polymer EFKA-8300 available through EFKA Additives BV, The Netherlands.

It is particularly surprising in connection with the present invention that the addition of fillers to the inventively proposed cyanate resins causes a higher toughness of the cured inventive materials that improves bonding of the inventive materials on substrates.

A few of the aforementioned fillers increase moreover the fire safety. Additional fillers that in particular can be added to improve the fire protection properties are halogen-containing, nitrogen-containing, or boron-containing materials, organo-phosphorus substances as well as materials that increase their volume upon exposure to heat.

Examples of inorganic flame retardants are oxides, hydroxides, oxide hydrates, mixed oxides, sulfides, sulfates, carbonates, phosphates and/or fluorides of Mg, Ca, B, Sr, Ba, Ti, V, Cr, Mn, Fe, Co, Ni, Cu, Zn, Zr, Nb, Mo, Cd, W, Ga, In, Si, Ge, Sn, Pb, Sb, or Bi; moreover ammonium polyphosphates, boric acid, red phosphorus, natural or synthetic silicon oxides such as diatomite, silica, quartz, silicates, talcum, kaolin, mica, flour of pumice, perlite, feldspar, mullite, wollastonite, and vermiculite that expands when exposed to heat, basalt, slate flour, glass flour, lava, pyrogenic or precipitated silicic acid, silica gels, micaceous silicates such as montmorillonites, bentonites, sulfates or carbonates of elements of the second main group of the periodic table of the elements, chalk, calcite or dolomite, silicon carbide, rock wool, graphite, glass beads, hollow glass beads, fiberglass, inorganic fiber fillers, inorganic pigments or dyes.

Examples of halogen-containing flame retardants are decabromo diphenyloxide, ethane-1,2-bis(pentabromophenol), ethylene-bis-tetrabromo phthalimide, brominated polystyrene, tri-bis-decabromo diphenylether, tetrabromobisphenol A and its derivatives, polybrominated bisphenyls, hexabromo cyclododecane, tetrabromo phthalic acid anhydride, its diesters/diethers, ethylene-bis(tetrabromo phthalimide), salts of tetrabromo phthalates, dibromomethyl dibromocyclohexane, dibromoneopentyl glycol, tribromo neopentyl alcohol, vinylbromide, 2,4,6-tribromophenol, bis(tribromophenylene oxide), pentabromo methylbenzene, poly(pentabromo benzyl acrylate), polydibromostyrene and others.

Further intumescent flame retardants can be selected, for example, from melamine phosphates and melamine cyanurates, without this constituting a limitation to these compounds. Further intumescent flame retardants are commercially available.

Suitable nitrogen-containing flame retardants encompass melamine that has intumescent properties, or melamine salts of boric acid, phosphoric acid or other inorganic acids.

Suitable boron-containing flame retardants are, for example, boric acid, borax, borates, zinc borate, metaborates of barium or calcium or tetrafluoro borates of sodium or potassium.

Suitable phosphorus-containing flame retardants can be inorganic or organic in nature. Examples are phosphoric acid esters, ammonium polyphosphate, triphenyl phosphate, tricresyl phosphate, (2-((hydroxymethyl)carbamyl)ethyl) phosphonic acid dimethyl ether or organic phosphinates.

In particularly preferred embodiments the organic phosphorus compounds contain groups with which they are or can be incorporated by polymerization into the resins of the present invention. Examples are phosphorus derivatives that contain hydroxy groups or cyanate groups, for example, phosphinate compounds of the formula (V)

[(R¹O)(R²)P(O)—(CHR³)ₘ—CR⁵(OH)]ₙR⁴ V

wherein R¹ and R² are, independent of one another, an optionally substituted alkyl, aryl, arylalkyl, alkylaryl, or alkylarylalkyl group with preferably 1-20 carbon atoms, wherein R³ and R⁵ each are independent from one another hydrogen or an optionally substituted alkyl, aryl, alkylaryl, arylalkyl or alkylarylalkyl group with preferably 1-20 carbon atoms, wherein R⁴ is hydrogen or an organic group with at least one and preferably up to 40 to 50 carbon atoms that is substituted n-times with the phosphorus-containing group and optionally has further substituents, wherein in the group R⁴, when it comprises more than one carbon atom, neighboring carbon atoms of a carbon chain can be interrupted by oxygen atoms, sulfur atoms or amino groups, wherein m is 0 or 1 and wherein n is an integer from 1 to 6, wherein R⁴ cannot be hydrogen when n is greater than 1.

The groups R¹ and R² can optionally contain hetero atoms such as silicon, nitrogen, phosphorus, oxygen, sulfur, halogens or organometallic groups. Preferably, at least one of these two groups contains an aryl group or is a phenyl group. Mentioned should be compounds of the formula (V) in which the carbon atoms of the groups R¹ and R² are connected to one another, for example, by formation of an oxaphospha phenanthrene system, oxaphospha hexane system, or an oxaphospha benzene system. In an especially preferred embodiment, the group (R¹O)(R²)P(O) is a derivative of 1:9, 10-dihydro-9-oxa-10-phospha phenanthrene-10-oxide (DOPO) having the following structural formula (VI):

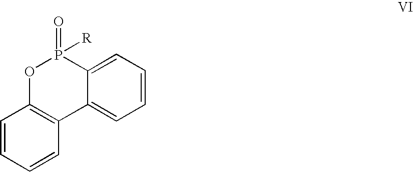

wherein R is H. For the listed especially preferred compounds, R is —(CHR³)ₘ—CH(OH)]ₙR⁴ in this formula. DOPO is a non-toxic substance with long-term shelf life.

EP 1 544 227 A1 discloses that compounds of the formula V and in particular those compounds that contain the DOPO group can be used in order to impart to organic material directly or indirectly a flame retardant property, in particular inter alia in that the compounds can be directly incorporated into the corresponding polymers. Hydroxy phosphinates of the formula (V) in which the index m is 0 or 1 are characterized in that they contain only one or two carbon atoms between this coupling group and the phosphorus atom and therefore have a high weight proportion of phosphorus; this improves the flame retardant action. Such phosphinates of the formula (V) are therefore particularly preferred for the purpose of the present invention; among them, primarily those in which m is 0 are preferred. An example for this is the reaction product of DOPO with (para)-formaldehyde wherein R in the above formula VI is the methylol group CH₂OH. this compound is also referred to as DOPOform.

Because of the presence of hydroxy groups the compounds of the formula (V) can be polymerized directly into the resins of the present invention. The same would be possible, of course, with analog cyanate compounds inasmuch as they are available, wherein the possibility of incorporation of such substances or similar substances is, of course, not limited to compounds where m is 0 or 1. Especially preferred is the use of compounds of the formula (V) with n equal or greater than 2 in the resins according to the invention, because these compounds with regard to the crosslinked structure of the resins have the same properties as the bifunctional or polyfunctional aromatic or aliphatic alcohol(s) substituted in the aliphatic group with at least one fluorine atom. In this context, attention should be paid that the molar ratio of the OCN groups to the OH groups in the starting materials for producing the resin remain within the inventive:boundaries (95:5 to 70:30).

The fillers can be used alone or in mixture. It was found that mixtures of different fillers of different materials are especially well suited. Their proportion in the resin can be, as mentioned before, preferably up to 20 percent by weight.

For producing the pre-polymerized compound, the cyanate component or components and the multifunctional alcohol or alcohols are dissolved, generally separately or jointly, in a suitable solvent in appropriate quantitative ratios with regard to the aforementioned molar ratios of OCN groups to OH groups. The alcohol component is therefore added in general in a ratio of 2 to 20 percent by weight. Solvents for cyanate ester resins are known to a person skilled in the art. A frequently employed solvent is methyl ethyl ketone. Inasmuch as the solutions are prepared separately, the solutions are subsequently mixed well. Optionally, for accelerating the crosslinking action, a further catalyst can be added; such catalysts are known in the art: for example, a metal-acetylacetonate complex can be used. Alternatively, the reaction partners can also be directly mixed with one another without employing a solvent.

Inasmuch as the prepolymer should contain one or several fillers, the filler or fillers can be admixed at any point in time to one of the solutions or the only solution (when the components are jointly dissolved) or the combined solutions of the cyanate and alcohol components or, if processing is done in the absence of a solvent, to the solvent-free component mixture or one of the starting components. Dispersion is done generally by auxiliaries that are available for this purpose. The solution or dispersion that can be optionally concentrated or diluted to a suitable viscosity can then be utilized as a casting resin, an adhesive, or a bonding agent or for any other purpose as disclosed above. Depending on the type of application, the solution/dispersion is subsequently optionally brought into its future form, for example, when used as an adhesive or bonding agent, applied to the substrate before it is dried, optionally with heat action, whereby the solvent is evaporated and the resin prepolymerized. The duration of the drying action and thus the degree of prepolymerization are selected in accordance with the respective requirement; the degree of prepolymerization should preferably be reached before the so-called gel point is reached so that a renewed melting and thus future shaping are possible. As a temperature range for the drying action, in particular a range between 80 degrees Celsius and 200 degree Celsius is suitable; this is not to be understood as a limitation of the temperature range. Alternatively, the resin can be stored in bulk with or without predrying. Independent of the obtained form, the resin is preferably cooled during storage (in general at approximately 0 degrees Celsius to −26 degrees Celsius, preferably at −26 degree Celsius). For final processing (shaping or molding and/or solidification with introduction of heat and optionally pressure) temperatures above room temperature, usually between 100 degrees Celsius and 200 degree Celsius, are used. Pressure greater than ambient pressure can be applied during this final processing step. Curing times of approximately 2 minutes to 20 minutes are generally employed. The pressures are to be matched to the respective processing technology and the desired product and are in general approximately 1 bar to 20 bar (approximately 1 bar is typical for a single-layer laminate; approximately 20 bar is typical for a laminate with several layers); these values are not to be understood as a limitation of the pressure range.

### BRIEF DESCRIPTION OF THE DRAWINGS

The only FIGURE is a graphic illustration of the fire properties of the substances of table II.

### DESCRIPTION OF PREFERRED EMBODIMENTS

In the following the invention will be explained with the aid of examples in more detail. The products employed in the examples refer to compounds or materials as defined in the following:

Primaset® PT15 (available from Lonza) is an oligo(3-methylene-1,5-phenylcyanate).

Primaset® PT30 (also available from Lonza) is an oligo(3-methylene-1,5-phenylcyanate) having a higher functionality than PT 15.

Primaset® LeCy (available from Lonza) is 4,4′-ethylidene diphenyl dicyanate.

Primaset® BADCy (available from Lonza) is 4,4′-isopropylidene diphenyl dicyanate.

XU366 is 1,3-phenylene-bis(1-methylethylidene) diphenyl dicyanate, available from Ciba or Huntsman.

### Examples Group 1

### General

Reactions of pure cyanate-ester resins (polyfunctional as well as bifunctional) with bisphenols

### Example 1.1

Reaction of Primaset® PT15 or Primaset® PT30 with bis(hydroxyphenyl) sulfide

### Example 1.2

Reaction of Primaset® PT15 or Primaset® PT30 with bisphenol A

### Example 1.3

Reaction of Primaset® PT15 or Primaset® PT30 (Lonza) with bis(hydroxyphenyl) sulfone

### Example 1.4

Reaction of Primaset® LeCy with bis(hydroxyphenyl) sulfide

### Example 1.5

Reaction of Primaset® LeCy with bisphenol A

### Example 1.6

Reaction of Primaset® LeCy with bis(hydroxyphenyl) sulfone

### Example 1.7

Reaction of Primaset® BADCy with bis(hydroxyphenyl) sulfide

### Example 1.8

Reaction of Primaset® BADCy with bisphenol A

### Example 1.9

Reaction of Primaset® BADCy with bis(hydroxphenyl) sulfone

The cyanate ester components as well as the bisphenol component are dissolved in methyl ethyl ketone (MEK) in quantitative ratios in accordance with the provisions of the present invention in weight ratios ensuring a molar ratio of the OCN groups to the OH groups between 95:5 and 70:30 in the starting materials. Typically, the solution(s) are prepared in that approximately 90-70 percent by weight, preferably approximately 80 percent by weight, of the resin component is combined with 10-30 percent by weight, preferably approximately 20 percent by weight, of methyl ethyl ketone. Subsequently, the solutions are combined and mixed while being stirred. Alternatively, the components can also be melted and mixed with one another by stirring. Optionally, a catalyst such as cobalt(III) acetylacetonate or chromium(III) acetylacetonate in a quantity of approximately 0.02 percent by weight to approximately 0.1 percent by weight, preferably in a quantity of 0.04 percent by weight to 0.05 percent by weight, relative to the quantity of the hydroxy component, can be added.

The resulting solution can be used to coat a substrate. The coated substrate is subsequently dried under heat, preferably at approximately 80 degrees Celsius to 130 degree Celsius, i.e., the solvent is evaporated and the resin is prepolymerized. The duration of drying, and thus the resulting state of prepolymerization, is within a range of approximately 1 minute to 10 minutes, depending on the selected temperature (and the actual resin composition); the desired prepolymerization state must be reached before reaching the so-called gel point so that a renewed melting and thus shaping are possible. The coated substrates are cooled for storing. For final processing (shaping under heat and optionally pressure), a temperature of 160 degree Celsius and pressing time of 800 seconds can be employed.

### Examples Group 2

### General

Reaction of combinations of cyanate ester resins with bisphenols

### Example 2.1

Reaction of mixtures of Primaset® PT15 and Primaset® PT30 with bis(hydroxyphenyl)sulfide

### Example 2.2

Reaction of mixtures of Primaset® PT15 and Primaset® PT 30 with bisphenol A

### Example 2

### 3-Reaction of mixtures of Primaset® PT15 and Primaset® PT 30 with bis(hydroxyphenyl) sulfone

### Example 2.4

Reaction of mixtures of Primaset® PT 15 and Primaset® LeCy with bis(hydroxyphenyl) sulfide

### Example 2.5

Reaction of mixtures of Primaset® PT15 and Primaset® LeCy with bisphenol A

### Example 2.6

Reaction of mixtures of Primaset® PT15 (Lonza) and Primaset® LeCy (Lonza) with bis(hydroxyphenyl) sulfone

### Example 2.7

Reaction of mixtures of Primaset® PT 30 and Primaset® LeCy with bis(hydroxyphenyl) sulfide

### Example 2.8

Reaction of mixtures of Primaset® PT30 and Primaset® LeCy with bisphenol A

### Example 2.9

Reaction of mixtures of Primaset® PT 30 and Primaset® LeCy with bis(hydroxyphenyl) sulfone

### Example 2.10

Reaction of mixtures of the aforementioned resins with Primaset® BADCy with bis(hydroxyphenyl) sulfide

### Example 2.11

Reaction of mixtures of the aforementioned resins with Primaset® BADCy with bisphenol A

### Example 2.12

Reaction of mixtures of the aforementioned resins with Primaset® BADCy and with the aforementioned bisphenols

Processing corresponds to that described in the Examples Group 1. The cyanate ester components are separately dissolved and subsequently combined with the bisphenol solution. The weight ratios correspond to those disclosed in Examples Group 1. The ratios of cyanate components can be selected within the resulting remaining range across the entire bandwidth.

### Examples Group 3

Reaction of cyanate ester resins with reactive organic phosphorus compounds as a flame retardant on the basis of formula (V) for improving flame resistance

### Example 3.1

Reaction of Primaset® PT15 with a bis(hydroxy phosphinate) of the following structural formula (VII); bis(hydroxyphosphinate) was prepared in accordance with Example 1.4 of EP 1 544 227 A1.

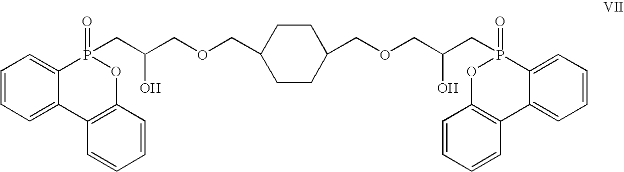

### Example 3.2

Reaction of Primaset® PT 30 with a bis(hydroxyphosphinate) of the following structural formula (VIII); bis(hydroxyphosphinate) was prepared in accordance with Example 1.1 of EP 1 544 227 A1.

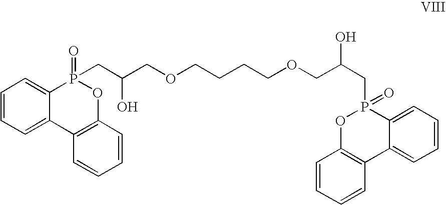

### Example 3.3

Reaction of Primaset® LeCy with bis(hydroxyphosphinate) of the above stuctural formula (VII)

### Example 3.4

Reaction of Primaset® BADCy with bis(hydroxyphosphinate) of the aforementioned structural formula (VIII)

### Example 3.5

Reaction of mixtures of any member of the group comprised of Primaset® PT15, PT30, LeCy, BADCy, with bis(hydroxyphosphinate) of the aforementioned structural formula (VII).

### Example 3.6

Reaction of mixtures of any member of the group comprised of Primaset® PT15, PT30, LeCy, BADCy, with bis(hydroxyphosphinate) of the aforementioned structural formula (VIII)

The resin component or components are melted and the bis(hydroxy phosphinate) of the structural formula (VII) or (VIII) is added slowly with continuous stirring to the melt. The bis(hydroxyphosphinate) melts also and the melted materials are mixed by stirring.

With this melt a substrate can be coated, and prepolymerization in the range of 80 degrees Celsius to 130 degrees Celsius is carried out. The prepolymerized resin is in a state below the gel point and can be melted again and subjected to shaping. Storage is possible by cooling. For final processing, a temperature of 160 degrees Celsius and a pressing time of 800 seconds can be selected.

### Examples Group 4

### General

Admixture of additives for obtaining improved surfaces in the cured state without loss of flame resistance for resin mixtures of Examples Groups 1, 2, 3.

### Example 4.1

Admixture of pyrogenic or highly dispersed silicic acid

### Example 4.2

Admixture of natural and/or synthetic intumescent micaceous silicate in particular on the basis of the montmorillonite type

### Example 4.3

Admixture of montmorillonite as in Example 4.2; however, montmorillonite is additionally organically modified

### Example 4.4

Admixture of inorganic phosphate-containing flame retardant

### Example 4.5

Admixture of DOPOform as a flame retardant

### Example 4.6

Admixture of a hydroxy phosphinate of the following structural formula (IX) as a flame retardant

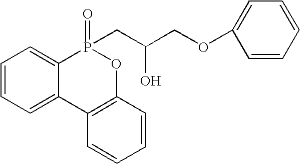

### Example 4.7

Admixture of combinations of the Examples 4.1 to 4.6.

The admixture of the additives is realized in the combined solutions or the melts that have been produced in accordance with Examples Group 1, Group 2, and Group 3 by using dispersion devices. The added quantity of additives can be preferably in sum total up to 20 percent by weight; when adding a single filler, the added amount is preferably maximally approximately 10 percent by weight.

### Examples Group 5

### A—Preparation of Specimens

For producing specimens, the corresponding cyanate resin and the bisphenol as disclosed in Examples Group 1, Group 2, or Group 3 are separately melted and subsequently mixed, or they are weighed into a glass flask and in general melted at approximately 120 degrees Celsius. In the case of employing bis(hydroxyphosphinate) of the formula (VII) or (VIII) as a comonomer, these substances are slowly added to the resin that has been heated to approximately 140 degrees Celsius with stirring. For cyanate resin mixtures with fillers, the fillers are subsequently dispersed in the melt as disclosed in connection with Examples Group 4. Subsequently, the resulting melt is degassed in vacuum and is poured into a casting mold that has been preheated to the predetermined curing temperature. The resin or the mixture is then cured in the casting mold in a heating cabinet in accordance with a desired curing regime.

### B—Special Examples of Specimens

### Example 5.1

5.57 g Primaset® BADCy (Lonza) are melted and heated to 140 degrees Celsius. 1.07 g 4,4′-dihydroxy benzophenone (premixed with 0.05 percent cobalt(III) acetylacetonate) are added to the liquid and the mixture is degassed in vacuum for approximately 10 minutes. The thus obtained prepolymer has a shelf life of more than 3 weeks at room temperature. Subsequently, the mixture is poured into a casting mold which has been preheated to 100 degrees Celsius and is cured in a heating cabinet in accordance with the following heating regime: 15 hours at 160 degree Celsius, 1 hour at 180 degrees Celsius. The resulting cured polymer is yellow, clear, has a glass transition temperature T_{g}=229 degree Celsius and a module G=950 MPa (dynamic-mechanical analysis).

### Example 5.2

5.57 g Primaset® BADCy (Lonza) are melted and heated to 140 degree Celsius. 1.25 g bis-(4-hydroxyphenyl) sulfide (premixed with 0.04 percent chromium(III) acetylacetonate) are added in portions to the liquid, the mixture is then stirred approximately 30 minutes at 160 degree Celsius and then degassed for 10 minutes under vacuum. The thus obtained prepolymer has a storage stability of more than 3 weeks at room temperature. Subsequently, the mixture is poured into a casting mold that is preheated to 120 degrees Celsius and is cured in a heating cabinet in accordance with the following heating regime: 15 hours at 160 degrees Celsius, 1 hour at 180 degrees Celsius. The resulting cured polymer is golden brown, clear, has a glass transition temperature T_{g}=237 degrees Celsius and a module G′=1,110 MPa (dynamic-mechanical analysis).

### Example 5.3

5.62 g Primaset® LeCy (Lonza) is degassed and heated to 70 degrees Celsius. 0.82 g bis(4-hydroxyphenyl) sulfide (premixed with 0.04 percent chromium(II) acetylacetonate) are added in portions to the liquid and the mixture is stored at 70 degree Celsius for approximately 30 minutes and subsequently degassed for ten minutes under vacuum. The thus obtained prepolymer has a storage stability (shelf life) of more than 3 weeks at room temperature. Subsequently, the mixture is poured into a casting mold that has been preheated to 70 degree Celsius and is cured in a heating cabinet in accordance with the following heating regime: one hour at 120 degree Celsius, two hours at 140 degree Celsius, one hour at 160 degree Celsius. The resulting cured polymer is yellow, clear and has a glass transition temperature of T_{g}=197 degrees Celsius and a module G′=990 MPa (dynamic-mechanical analysis) as well as thermal expansion coefficients of 54 ppm/K below and 163 ppm/K above the glass transition temperature (thermo-mechanical analysis). At 403 degrees Celsius the polymer has a mass loss of 10 percent in air (thermogravimetric analysis).

### Example 5.4

4.756 g Primaset® LeCy (Lonza) are degassed and heated to 70 degrees Celsius. To the liquid, 0.436 g bis(4-hydroxyphenyl) sulfide (premixed with 0.04 percent chromium(III) acetylacetonate) are added in portions, the mixture is stirred for appr. 30 minutes at 70 degrees Celsius and then degassed for 10 minutes in vacuum. The thus obtained prepolymer has a shelf life of more than 3 weeks at room temperature. The mixture is poured into a casting mold preheated to 70 degrees Celsius and cured in a heating cabinet according to the following regime: 2 hours at 100 degrees Celsius, 2 hours at 120 degrees Celsius, 2 hours at 140 degrees Celsius, 1 hour at 160 degrees Celsius. The resulting cured polymer is yellow, clear, has a glass transition temperature T_{g}=222 degrees Celsius and a module G=1,010 MPa (dynamic-mechanical analysis).

### Example 5.5

65 g Primaset® PT15 (Lonza), 25 g Primaset® LeCy (Lonza) and 10 g bisphenol A are weighed into a flask and melted at 120 degrees Celsius. The melt is subsequently degassed in vacuum. Into the degassed mixture 2 parts Aerosil® (Degussa) and/or 2.5 parts Nanofil 2 (Südchemie) and/or 10 parts SLM P52 (Wacker) and/or 8.8 parts Exolit OP 930 are added in portions and admixed to the mixture with the aid of a dispersion stirrer. The resulting mixture is subsequently put into a casting mold preheated to 140 degrees Celsius and then cured in accordance with the following heating regime: 6 hours at 140 degrees Celsius; 1 hour at 250 degrees Celsius. The resulting polymer is yellowish, opaque, has a glass transition temperature of 217 degrees Celsius and can be polished to an average surface roughness of Ra=0.033 micrometers.

### Example 5.6

90 g BADCy and 10 g bis(hydroxyphenyl) sulfone are weighed into a flask and melted at 120 degrees Celsius. The mixture is subsequently degassed in vacuum and poured into a preheated casting mold. Curing is done in accordance with the following regime: heating from 50 degrees Celsius to 120 degrees Celsius in 3 hours; 2 hours at 120 degrees Celsius; heating to 180 degrees Celsius in 1 hour; 2 hours at 180 degree Celsius. The resulting polymer has a glass transition temperature of 205 degrees Celsius and module G′=1,470 MPa.

### Example 5.7

92 g Primaset® BADCy (Lonza) are heated to 140 degrees Celsius and melted. Into the melt, 11.0 g of the aforementioned bis(hydroxyphosphinate) of formula (VIII) are added slowly with continuous stirring. After the bis(hydroxyphosphinate) has completely dissolved in the BADCy melt, the mixture is degassed for 10 minutes in a vacuum. The mixture is subsequently poured into a casting mold preheated to 140 degrees Celsius and is cured in the heating cabinet in accordance with the following curing regime: six hours at 140 degrees Celsius, one hour at 250 degrees Celsius. The resulting polymer is orange, clear, and has glass transition temperature T_{g}=268 degrees Celsius.

### Example 5.8

90 g BADCy and 10 g bisphenol A are weighed into a flask and melted at 120 degrees Celsius and subsequently degassed in vacuum. To this mixture, 6.5 g Exolit AP 422 (Clariant) is added and admixed with stirring. The mixture is then poured into a preheated casting mold and subsequently cured in accordance with the following regime: 5 hours at 140 degree Celsius, 1 hour at 250 degrees Celsius.

The fire properties of this polymer in comparison to a pure resin plate made form BADCy and bisphenol A are shown infra.

### C—Properties of the Specimens

The following Table I shows the minimum temperature profiles for curing of cyanate ester resins modified with bisphenol A which provide acceptable fracture toughness and in the polymerized state at room temperature have a storage stability (shelf life) of a minimum of 3 weeks. For comparison, corresponding data of unmodified cyanate ester resins are provided.

TABLE I

| | | Ratio | | Curing Regime |
|---|---|---|---|---|
| Cyanate | Phenol | [%] | K1c | [° C.-h] |
| BADCy | — | 100 | 0.2 | 180-30 |
| | | | 0.54 | 220-2 + 200-2 + 180-.30 |
| BADCy | Bisphenol A | 85/15 | Not measurable | 140-2 |
| | | | 1.06 | 140-6 |
| PT15 | — | 100 | <0.27 | 160-6 |
| | | | 0.5 | 160-20 |
| PT15 | Bisphenol A | 85/15 | <0.37 | 130-2 |
| | | | 0.68 | 140-2 |
| PT30 | — | 100 | Not measurable | 160-8 |
| | | | 0.435 | 160-20 |
| PT30 | Bisphenol A | 85/15 | Not measurable | 110-2 |
| | | | 0.435 | 130-2 |
| XU366 | — | 100 | 0.2 | 180-8 |
| | | | 1.08 | 180-16 + 160-4 |
| XU366 | Bisphenol A | 85/15 | Not measurable | 100-2 |
| | | | 1 | 130-1 |

Abbreviations:
K1c = critical stress intensity factor in mode 1 (mode 1 = tensile load)

In the following Table II the fire properties of three of the resin pairs (unmodified/modified) listed in Table I are shown.

TABLE II

| | IT | HRRpeak | HRR300 | THR300 | TSR | Curing |
|---|---|---|---|---|---|---|
| Substances | [s] | [kW/m²] | [kW/m²] | [MJ/m²] | [m²/m²] | [° C.-h] |
| PT15 | 72 | 195 | 52 | 16 | 320 | 200-4 + 180-4 + 160-4 |
| PT15 + BA 85/15 | 61 | 243 | 88 | 26.7 | 667 | 140-2 |
| PT30 | 64 | 274 | 137 | 42.11 | 956 | 200-4 + 180-4 + 160-4 |
| PT30 + BA 85/15 | 80 | 278 | 92 | 28.5 | 808 | 130-2 |
| XU366 | 84 | 254 | 138 | 41.8 | 1972 | 180-16 + 160-4 |
| XU366 + BA 85/15 | 59 | 305 | 150.3 | 45.6 | 2079 | 160-6 |

Abbreviations
BA = bisphenol A
IT = ignition time
HRRpeak = heat release rate peak (maximum heat release rate)
HRR300 = heat release rate above 300 seconds
THR300 = total heat release (total heat released within 300 seconds)
TSR = total smoke release

The fire properties of the substances of Table II are graphically illustrated in the only FIGURE.

In the following Table III the improvement of the fire properties of a resin made from BADCy and bisphenol A and modified with Exolit AP 422 are listed in comparison to a pure resin.

TABLE III

| | | HRRpeak | HRR300 | TSR |
|---|---|---|---|---|
| Substances | IT [s] | [kW/m²] | [kW/m²] | [m2/m²] |
| BADCy + bisphenol A + Exolit | 125 | 203 | 133 | 4,265 |
| (90 + 10 + 6,5 parts) | | | | |
| BADCy + bisphenol A | 65 | 259 | 125 | 2,586 |

In the following Table IV the glass transition temperatures (T_{g}) and the module G′ of the reactions of BADCy with bis(hydroxyphenyl) sulfone are disclosed.

TABLE IV

| | | Tg | |
|---|---|---|---|
| Substances | Curing | [° C.] | G′ [MPa] |
| BADCy + BHPS | 50 to 120° C. in 3 h, 2 h at 120° C. | 151 | 1600 |
| 90 + 10 | | | |
| BADCy + BHPS | 50 to 120° C. in 3 h, 2 h at | 185 | 1540 |
| 90 + 10 | 120° C., in 1 h to 180° C., 2 h at | | |
| | 180° C. | | |
| BADCy + BHPS | 50 to 120° C. in 3 h, 2 h at 120° C. | 152 | 1560 |
| 95 + 5 | | | |
| BADCy + BHPS | 50 to 120° C. in 3 h, 2 h at | 205 | 1470 |
| 95 + 5 | 120° C., in 1 h to 180° C., 2 h at | | |
| | 180° C. | | |

Abbreviations:
BHPS = bis(hydroxyphenyl) sulfone

The specification incorporates by reference the entire disclosure of German priority documents 10 2006 022 058.7 having a filing date of 11 May 2006; 10 2006 041 037.8 having a filing date of 1 Sep. 2006; and 10 2006 062 248.0 having a filing date of 22 Dec. 2006.

While specific embodiments of the invention have been shown and described in detail to illustrate the inventive principles, it will be understood that the invention may be embodied otherwise without departing from such principles.

What is claimed is:

1. A prepolymer prepared from:
starting material a) consisting of one or more bifunctional or polyfunctional organic cyanates;
starting material b) consisting of one or more bifunctional or polyfunctional aromatic alcohols and/or one or more bifunctional or polyfunctional aliphatic alcohols substituted in the aliphatic group with at least one fluorine atom, wherein the starting materials a) and b) are present in a weight ratio ensuring a molar ratio of the OCN groups to the OH groups between 95:5 and 70:30 in the starting materials a) and b); and
wherein the prepolymer has a degree of crosslinking that is below the gel point of the prepolymer;
with the proviso that the prepolymer is not a prepolymer prepared from the dicyanate derivative of bisphenol A and either bisphenol A or a brominated derivative of bisphenol A or 4,4′-thiodiphenol (TDP), at least when no filler is present, and with the proviso that the prepolymer is not a prepolymer that is prepared form exclusively aliphatic dicyanates and exclusively aliphatic diols.

2. The prepolymer according to claim 1, wherein at least one of said one or more bifunctional or polyfunctional organic cyanates is selected from aromatic cyanates.

3. The prepolymer according to claim 1, wherein at least one of said one or more bifunctional or polyfunctional organic cyanates is selected from the group consisting of the cyanates of the structural formulas I, II and III, and of prepolymers of said cyanates of said structural formulas I, II, and III: 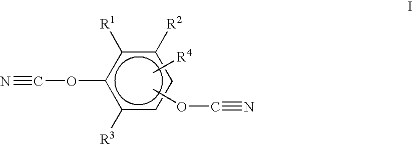
wherein R¹ to R⁴ are, independent from one another, hydrogen, straight-chain or branched C₁-C₁₀ alkyl, C₃-C₈ cycloalkyl, C₁-C₁₀ alkoxy, halogen, phenyl or phenoxy, wherein the alkyl groups or aryl groups can be fluorinated or partially fluorinated; 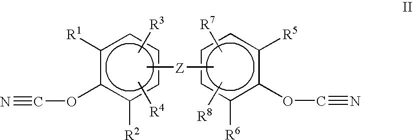
wherein R⁵ to R⁸ are the same as R¹ to R⁴ above and Z is a chemical bond, SO₂, CF₂, CH₂, CHF, CH(CH₃), isopropylene, hexafluoro isopropylene, C₁-C₁₀ alkylene, O, NR⁹, N═N, CH═CH, COO, CH═N, CH═N—N═CH, alkylene oxyalkylene with C₁-C₈ alkylene, S, Si(CH₃)₂, 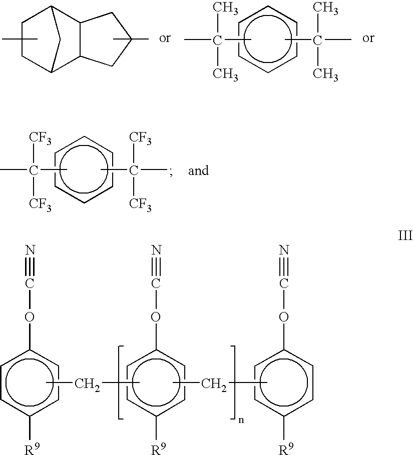
wherein R⁹ is hydrogen or C₁-C₁₀ alkyl and n is an integer of 0 to 20.

4. The prepolymer according to claim 1, wherein at least one of said one or more bifunctional or polyfunctional aromatic alcohols is a bifunctional or polyfunctional phenol.

5. The prepolymer according to claim 1, wherein at least one of said one or more bifunctional or polyfunctional aromatic alcohols is selected from the group consisting of compounds having a structure according to the structural formulas I, II, and III, with the proviso that the cyanate groups in the structural formulas I, II, and III are replaced with OH groups: 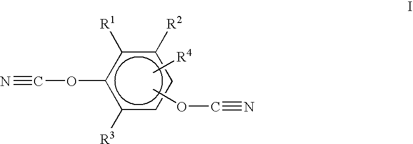
wherein R¹ to R⁴ are, independent from one another, hydrogen, straight-chain or branched C₁-C₁₀ alkyl, C₃-C₈ cycloalkyl, C₁-C₁₀ alkoxy, halogen, phenyl or phenoxy, wherein the alkyl groups or aryl groups can be fluorinated or partially fluorinated; 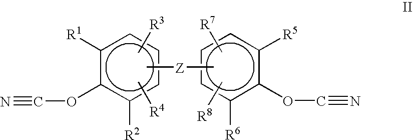
wherein R⁵ to R⁸ are the same as R¹ to R⁴ above and Z is a chemical bond, SO₂, CF₂, CH₂, CHF, CH(CH₃), isopropylene, hexafluoro isopropylene, C₁-C₁₀ alkylene, O, NR⁹, N═N, CH═CH, COO, CH═N, CH═N—N═CH, alkylene oxyalkylene with C₁-C₈ alkylene, S, Si(CH₃)₂, 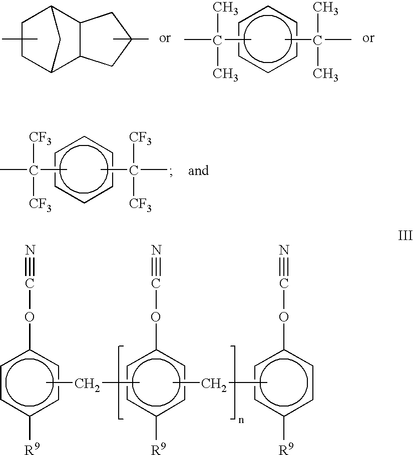
wherein R⁹ is hydrogen or C₁-C₁₀ alkyl and n is an integer of 0 to 20.

6. The prepolymer according to claim 1, wherein at least one of said one or more bifunctional polyfunctional cyanates is selected from the group consisting of novolac cyanates, bisphenol A dicyanate derivative, 4,4′-ethylidene diphenyl dicyanate and compounds of the structural formula III 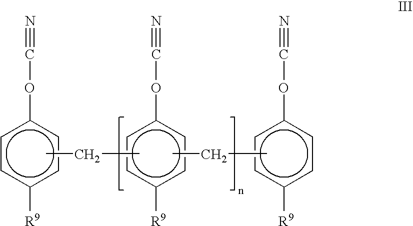
wherein n is 1, 2, or 3, R⁹ is hydrogen and the methylene group is in the ortho position relative to the cyanate position, respectively.

7. The prepolymer according to claim 6, wherein at least one of said one or more bifunctional or polyfunctional aromatic alcohols is selected from the group consisting of bisphenol A and bis(hydroxyphenyl) sulfide.

8. The prepolymer according to claim 1, wherein at least one of said one or more bifunctional or polyfunctional aromatic alcohols is selected from the group consisting of bisphenol A and bis(hydroxyphenyl) sulfide.

9. The prepolymer according to claim 1, comprising one or more fillers selected from the group consisting of inorganic microfillers, optionally organically modified and/or coated, and inorganic nanofillers, optionally organically modified and/or coated.

10. The prepolymer according to claim 9, wherein at least one of said one or more fillers contains organophosphorus components.

11. The prepolymer according to claim 1, comprising one or more fillers, in particular those having very high surface areas and/or small particle sizes, selected from the group consisting of silicon dioxide, ceramic materials, organically modified silicones or siloxanes or mixtures thereof.

12. The prepolymer according to claim 1, comprising one or more fillers, wherein said one or more fillers is contained in the filled prepolymer in a quantity of up to 30 percent by weight, preferred up to 20 percent by weight, and more preferred 15 percent by weight.

13. The prepolymer according to claim 1, comprising at least one additive.

14. The prepolymer according to claim 13, wherein the at least one additive is a surface-modifying agent or a surface tension reducing agent.

15. A method for preparing a prepolymer according to claim 1, the method comprising the steps of:
mixing or separately dissolving or jointly dissolving in one solvent or different solvents
starting material a) consisting of one or more bifunctional or polyfunctional organic cyanates;
starting material b) consisting of one or more bifunctional or polyfunctional aromatic alcohols and/or one or more bifunctional or polyfunctional aliphatic alcohols substituted in the aliphatic group with at least one fluorine atom, wherein the starting materials a) and b) are present in a weight ratio ensuring a molar ratio of the OCN groups to the OH groups between 95:5 and 70:30 in the starting materials a) and b), with the proviso that the starting materials a) and b) do not include the dicyanate derivative of bisphenol A and either bisphenol A or a brominated derivative of bisphenol A or 4,4′-thiodiphenol (TDP), at least when no filler is present, and do not include exclusively aliphatic dicyanates and exclusively aliphatic diols; and,
when dissolving is done separately so as to produce separate solutions, combining the separate solutions to a combined solution.

16. The method according to claim 15, further comprising the step of admixing at least one filler into the only solution, when dissolving jointly; into one of the separate solutions; or into the combined solution.

17. The method according to claim 15, further comprising the step of adjusting, by evaporating the solvent or adding a solvent, a viscosity of the only solution, when dissolving jointly, or of the combined solution.

18. The method according to claim 15, further comprising the step of converting the only solution, when dissolving jointly, or the combined solution into a form that is close to a final form followed by heating and/or drying.

19. The method according to claim 18, wherein the step of drying is carried out at a temperature of 80 degrees Celsius to 200 degrees Celsius.

20. The method according to claim 15, further comprising the step of heating and/or drying the only solution, when dissolving jointly, or the combined solution in bulk.

21. The method according to claim 20, wherein the step of drying is carried out at a temperature of 80 degrees Celsius to 200 degrees Celsius.

22. A molded body prepared with a prepolymer according to claim 1 by curing the prepolymer at a pressure greater than ambient pressure and/or at a temperature higher than room temperature.

23. The molded body according to claim 22 in the form of a laminate.
